(19) United States
(12) Patent Application Publication
(10) Pub. No.: US 2009/0051657 A1
(43) Pub. Date: Feb. 26, 2009

(54) Display button device

(76) Inventors: Kyongdo Kim, Youngin-si (KR); Hyunah Jang, Youngin-si (KR); Hyungjun Namgung, Youngin-si (KR); Woojong Lee, Youngin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/229,395

(22) Filed: Aug. 21, 2008

(30) Foreign Application Priority Data
Aug. 23, 2007 (KR) 10-2007-0084951

(51) Int. Cl. G06F 3/02

(52) U.S. Cl. 345/168

(57) ABSTRACT

A button device having display functionality is disclosed. The display buttons have button mechanisms, which, when depressed actuate a switch, creating a signal detected by electronics for the button device. Each button is configured to display an image, which can be changed by a display driver. Accordingly, the display button device can dynamically change the image associated with each button and can correspondingly change the function of each button.

### CROSS-REFERENCE TO RELATED APPLICATION

This application is based on and claims priority to Korean Patent Application No. 10-2007-0084951 filed on Aug. 23, 2007 in the Korean Intellectual Property Office (KIPO), the entire contents of which are hereby incorporated by reference.

### BACKGROUND

1. Field

The field relates to display button devices.

2. Description of the Related Technology

Generally, electronic devices (for example, a mobile communication terminal) include button devices for easily inputting various commands. For an example, in the button devices, characters, numbers or specific symbols have been previously allocated to each button. Various operations such as phone calling and receiving, character inputting and sending are performed in the electronic devices by operation of the buttons by a user.

However, the conventional button device has a disadvantage that it is unsuitable for current electronic devices performing various and complex functions because the characteristic characters, numbers or specific symbols have been defined for each button. For an example, character inputting is difficult or impossible in global roaming because predetermined characters are fixedly allocated to each button.

In addition, there is a problem that it is not easy to use an MP3 function or a camera function or a DMB function because many button operations should be done when the user wants to use the functions in the mobile communication terminals. That is, the conventional button device has the problem that the user should operate the buttons in many situations for performing a desired function. That is, the user interface depth is deep.

On the other hand, technologies using a touch screen have been developed as a button display device for solving the problem as described above. However, the touch screen has a problem that commands are inexactly input or the same command is repeatedly input several times because the user cannot feel a sense of pressing when the user touches or presses the button.

Furthermore, the button device using the touch screen has additional problems that the quality of image is degraded by many scratches generated on the display region when the buttons are operated for a long time as well as the display region is damaged by excessive pressing.

### SUMMARY OF CERTAIN INVENTIVE ASPECTS

One aspect is a display button device, including a display providing images, a first substrate located on the display and provided with a plurality of holes arranged with a constant gap, a second substrate located on the first substrate and provided with a plurality of openings formed on regions corresponding to the holes and provided with a plurality of switches formed on upper surfaces corresponding to outer circumference edges of the openings, a third substrate located on the second substrate and provided with buttons formed on regions corresponding to the openings and the switches, and a fourth substrate located on the third substrate.

### BRIEF DESCRIPTION OF THE DRAWINGS

FIGS. 1a to 1c are respectively front perspective view, front exploded perspective view and rear perspective view illustrating a display button device;

FIGS. 2a to 2c are respectively sectional views taken along “2a-2a” line, “2b-2b” line and “2c-2c” line of FIG. 1a;

FIG. 3 is a plan view illustrating a display region by a display of the display button device;

FIG. 4 is a plan view illustrating a second substrate of the display button device;

FIGS. 5a and 5b are sectional views illustrating switches formed on the second substrate of the display device;

FIG. 6 is a magnified plan view illustrating a region of a third substrate of the display button device;

FIGS. 7a and 7b are sectional views illustrating a projection formed on the third substrate;

FIGS. 8a to 8c are magnified sectional views illustrating a fourth substrate of the display button device; and

FIG. 9 is a plan view illustrating the fourth substrate of the display button device.

### DETAILED DESCRIPTION OF CERTAIN INVENTIVE EMBODIMENTS

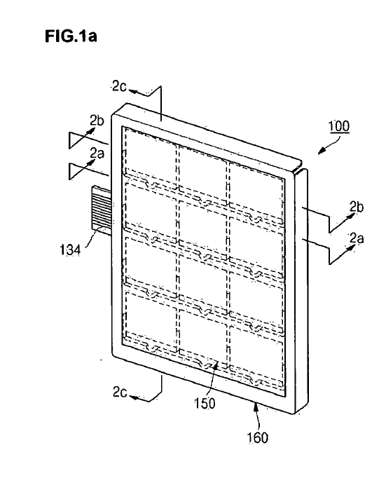

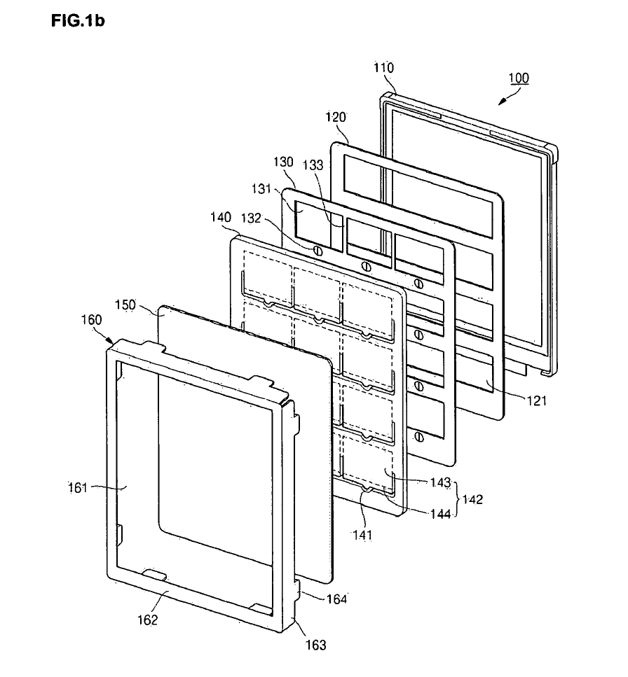

FIGS. 1a to 1c are respectively front perspective view, front exploded perspective view and rear perspective view illustrating a display button device according to the present invention.

Referring to FIGS. 1a to 1c, the display button device 100 includes a display 110, a first substrate 120 located on the display 110, a second substrate 130 located on the first substrate 120, a third substrate 140 located on the second substrate 130, a fourth substrate 150 located on the third substrate 140 and, a bezel 160 fixing the display 110, first substrate 120, second substrate 130, third substrate 140 and fourth substrate 150 together.

The display 110 is located at a rear position and displays various types of images in the forward direction. That is, the display 110 changes characters, numbers, symbols, still images and moving images according to a user's choice to display them. The display may, for example, include a passive matrix organic light emitting display, an active matrix organic light emitting display, a liquid crystal display, an electrophoretic display or their equivalents, but is not limited thereto. The display 110 may be provided in a panel and may further include a driving board 111 for driving the display 110.

The first substrate 120 is located on the display 110 and includes a plurality of holes 121 arranged with a constant gap. For an example, the hole 121 is formed in the shape of horizontally long hole. Four to six holes may be formed in a vertical direction, but not limited thereto. The first substrate 120 may be made of any one selected from metal, ceramics, plastic and its equivalents, but not limited thereto. The first substrate 120 is located at a region corresponding to a switch, thereby preventing a bruise defect or a damage of the display 110 caused by operation of the switch.

The second substrate 130 is located on the first substrate 120 and includes a plurality of opening 131 formed on regions corresponding to the holes 121. For an example, about three or four opening 131 may be formed the second substrate 130 corresponding to one hole 121 formed on the first substrate 120, but not limited thereto. Further, a barrier wall 133 may be further formed between the longitudinal openings 131. In addition, a switch 132 is formed on a surface of the second substrate 130 in the outer circumference edge of each opening 131. Here, the second substrate 130 may be a rigid or flexible circuit board provided with a wiring pattern, or its equivalents, but not limited thereto. The switch 132 may be a dome switch that is electrically conducted while being depressed, or its equivalent, and the switch 132 is not limited thereto. In addition, a circuit board 134 electrically coupled to the switch 132 may be further connected to the second substrate 130. The circuit board 134 may be electrically coupled to the driving board 111 or an external device not shown in the drawing.

The third substrate 140 is located on the second substrate 130 and buttons 142 are formed on regions corresponding to the openings 131 and switches 132. Twelve buttons are shown in the drawing, but the number is not limited. An image from the display 110 is displayed to the outside through the button 142. The button 142 may be formed of a first region 143 connected to the third substrate 140, and a second region 144 extending from the first region 143 and separated by a cut 141. Accordingly, when the user presses the button 142, the second region 144 is somewhat bent backwardly so as to press the switch 132. When the user releases the button 142, the second region 144 returns to its original position and releases the switch 132. In this embodiment, it is beneficial that the third substrate 140 is formed of transparent and elastic polycarbonate or an equivalent so as to display the image of the display 110 to the outside and to releasably depress the button 142. But the material of the third substrate 140 is not limited thereto. The images of the display 110 are shown through each of the buttons, and the function of each of the buttons may be modified through user interaction with the device. Accordingly, the image displayed through each button may be related to the function associated with the button, where the function and the corresponding image of each button may be dynamically determined.

The fourth substrate 150 is located on the third substrate 140. The fourth substrate 150 prevents foreign materials from entering into the third substrate 140, second substrate 130, first substrate 120 and display 110. The fourth substrate 150 may also be formed of soft material so as to display the image through the button 142 of the third substrate 140 as well as to provide a good touch feel to the user. For this purpose, the fourth substrate 150 may be made of transparent and soft PET (polyethylene terephtalate) resin, silicone resin or their equivalents, but not limited thereto.

The bezel 160 is combined with circumferences of the display 110, first substrate 120, second substrate 130, third substrate 140 and fourth substrate 150 so as to fix them together. A rectangular hole 161 is formed at a roughly middle part of the bezel 160. The bezel 160 may be formed of an edge part 162 contacted with an upper circumference of the fourth substrate 150, a side surface part 163 extended and bent by a certain length from the edge part 162 and contacted with the perimeter of the display 110, first substrate 120, second substrate 130, third substrate 140 and fourth substrate 150, and a plurality of protrusions 164 bent to contact a rear part of the display 110. The bezel 160 may be made of metal, plastic and its equivalents, but is not limited thereto.

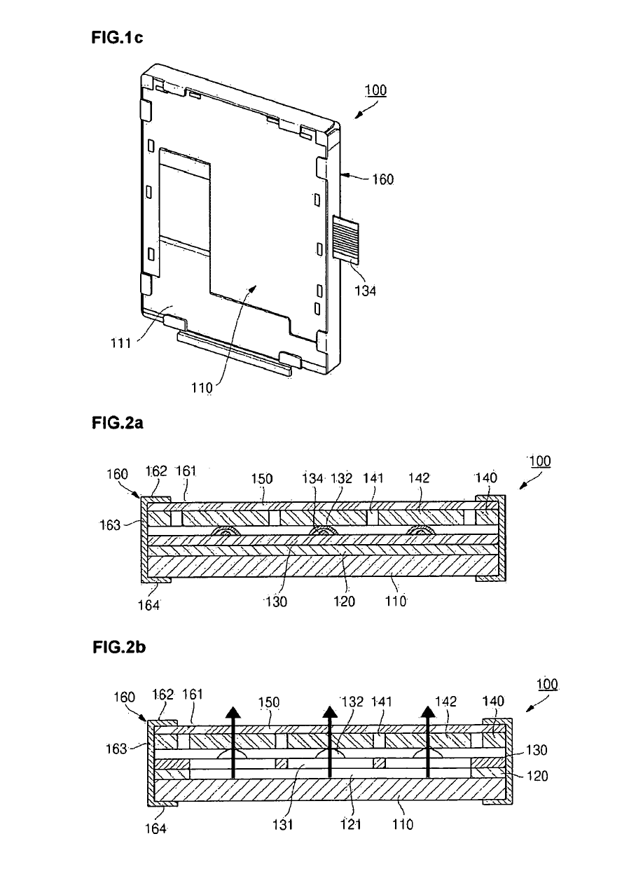

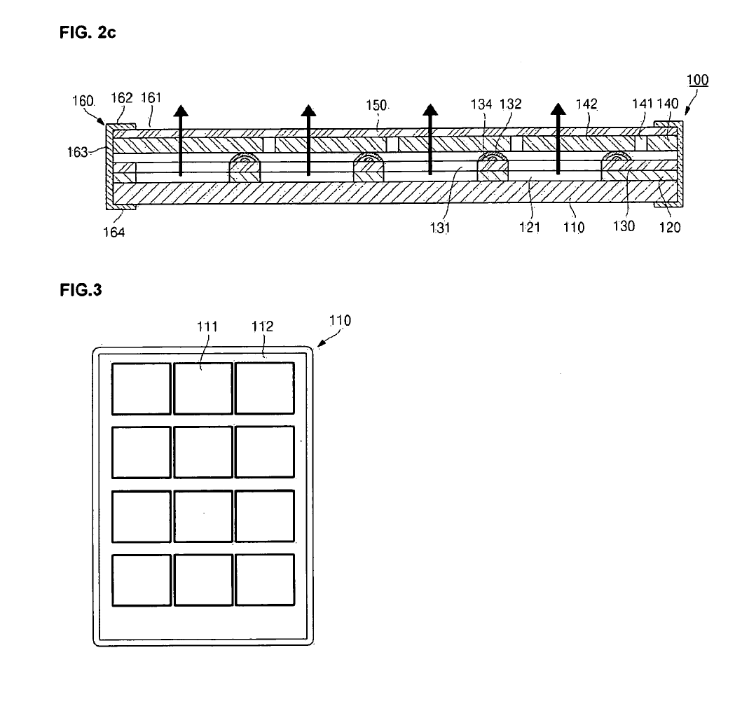

FIGS. 2a to 2c are respectively sectional views taken along “2a-2a” line, “2b-2b” line and “2c-2c” line of FIG. 1a.

Referring to FIG. 2a, the display button device 100 includes the display 110, first substrate 120, second substrate 130, third substrate 140 and fourth substrate 150 stacked in that order with both sides surrounded by the bezel 160.

The first substrate 120 is located on the upper surface of the display 110, and the second substrate 130 is located on the first substrate 120. The plurality of switch 132 and the conduction pattern 134 are formed on the second substrate 130. The third substrate 140 provided with the plurality of button 142 is located on the upper surface of the second substrate 130. The cut 141 is formed between the buttons 142 so as to enable each button 142 to independently operate. When the user presses the button 142, the button 142 depresses the switch 132, thereby allowing the switch 132 to be electrically coupled to the conduction pattern 134.

The first substrate 120 is located on the region corresponding to the switch 132 and button 142, thereby allowing the first substrate 120 to absorb and reduce pressure applied to the button 142 and switch 132. That is, a bruise defect or a damage of the display 110 is prevented by the first substrate 120.

Referring to FIG. 2b, in the display button device 100, the image of the display 110 is displayed to the outside through the hole 121 of the first substrate 120, the opening 131 of the second substrate 130, the button 142 of the third substrate 140, and the fourth substrate 150. Both the third substrate 140 and the fourth substrate 150 are made of transparent material, thereby allowing the image of the display 110 to be easily displayed therethrough. The fourth substrate 150 is located on the top part of the display button device 100, thereby preventing scratching of the third substrate 140, and preventing foreign materials form penetrating into the third substrate 140, second substrate 130, first substrate 120 and the display 110. The arrows in the drawing indicate the image displaying direction.

Referring to FIG. 2c, the image of the display 110 is displayed to the outside through the hole 121 of the first substrate 120, the opening 131 of the second substrate 130, the button 142 of the third substrate 140, and the fourth substrate 150. Furthermore, the first substrate 120 is a circumference edge of the hole 121, the second substrate 130 is a circumference edge of the opening 131, and the switches 132 are located at a circumference edge of a path that the image of the display 110 is displayed through, and thus do not interrupt the image output of the display 110. It is not that all regions of the display 110 display the image, but rather, only regions corresponding to the openings 131 of the second substrate 130 display an image. Thus, according to the display 110, power consumption can be substantially lowered. An arrow in the drawing indicates an image displaying direction.

FIG. 3 is a plan view illustrating a display region by a display of the display button device.

Referring to FIG. 3, the display 110 includes twelve driving boards 111, but is not limited thereto. Further, the driving boards 111 have edges 112 along their perimeter. In other words, in the display 110, display operation is performed through only the driving board 111, and not performed in the edges 112. Accordingly, when a passive matrix organic light emitting display or an active matrix organic light emitting display is used as the display 110, power consumption is significantly reduced. Of course, when a liquid crystal display may be used as the display 110.

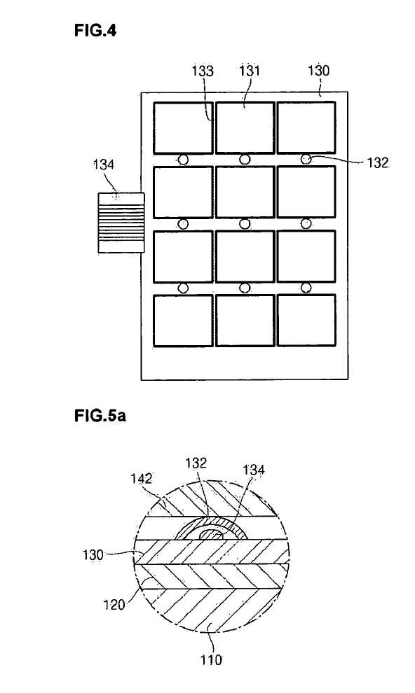

FIG. 4 is a plan view illustrating a second substrate of the display button device.

Referring to FIG. 4, the second substrate 130 includes openings 131 arranged with a plurality of rows and columns. The switch 132 is formed between the openings 131 of any one row and the openings 131 of an adjacent row. In addition, the barrier wall 133 is formed between the opening 131 of any one column and the opening 131 of other adjacent column so as to clearly separate the images from the display. Here, it is desirable that the switch 132 is small so as to provide a wider area of the opening 131 to be used as display area.

The circuit board 134 is connected to one side of the second substrate 130, and the circuit board 134 is electrically coupled to the switches 132 through the wiring pattern (not shown). Accordingly, an electrical conduction signal by the switches 132 is transferred to the outside through the circuit board 134. The circuit board 134 is connected to a driving board included in the display, or connected to an external device.

FIGS. 5a and 5b are sectional views illustrating switches formed on the second substrate of the display device.

The switch 132 may be a dome switch or another switch that is contacted with the circuit board 134 of the second substrate 130 when pressure is applied to the button 142 from an upper part to a lower part. The switch is not limited thereto.

In addition, the switch 132 should be small so as to provide a more wide display region. Thus, when only one dome switch is used as the smallest switch 132 as shown in FIG. 5a, a stroke force and a stroke distance may be smaller.

Thus, a switch 1320 having standard stroke force and stroke distance can be realized by using two dome switches as shown in FIG. 5b. That is, the switch 1320 having relatively large stroke force and stroke distance is realized by installing a first dome switch 132a on the second substrate 130 by an ordinary method, and installing a second switch 132b having the same size and shape as the first dome switch 132a on the upper part of the first dome switch 132a. Thus, when the button 142 presses the second switch 132b of the switch 1320, the second switch 132b presses against the first dome switch 132a, and then the first dome switch 132a contacts the conduction pattern 134, thereby allowing switching operation to be performed. Of course, the largest display region can be obtained by using relatively small first and second dome switches 132a and 132b.

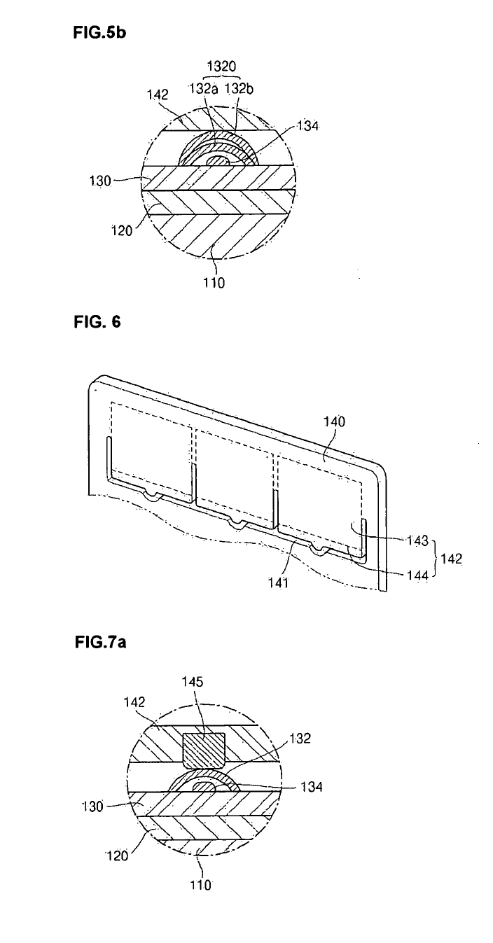

FIG. 6 is a magnified plan view illustrating a region of a third substrate of the display button device.

Referring to FIG. 6, the third substrate 140 includes a plurality of buttons 142. Each button 142 is formed of a first region 143 connected to the third substrate 140 and a second region 144 extending from the first region 143 and separated from the third substrate 140 by the cut 141. Here, a lower end of the second region 144 corresponds to the switch 132 formed at the second substrate 130. Accordingly, when the user presses the lower end of the second region 144 of the button 142, the switch 132 is actuated. A region indicated by a dotted line in the drawing is a region corresponding to the display region of the display 110.

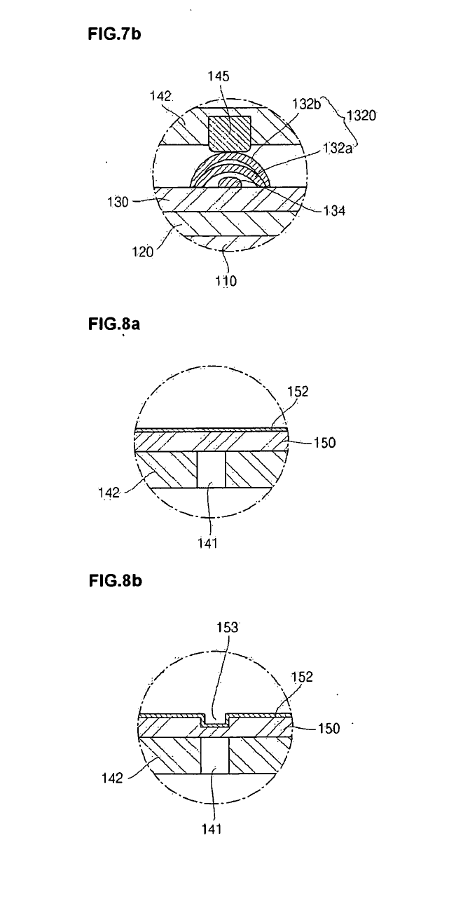

FIGS. 7a and 7b are sectional views illustrating a projection formed on the third substrate.

Referring to FIG. 7a, operation of the switch 132 formed on the second substrate 130 can be improved by additionally providing a projection 145 on the button 142 of the third substrate 140. It is advantageous that the projection 145 is made of a soft material so as to prevent the switch 132 from being damaged. For example, the projection 145 may be made of any one selected from an elastomer or its equivalents, but the projection 145 is not limited thereto.

Referring to FIG. 7a, the projection 145 can be used in embodiments using switch 1320 having the first and second dome switches 132a and 132b. Likewise, the projection 145 may be made of an elastomer or an equivalent thereof.

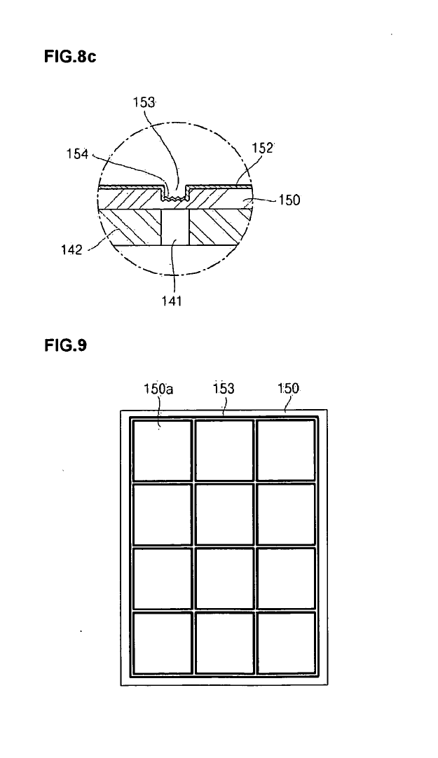

FIGS. 8a to 8c are magnified sectional views illustrating a fourth substrate of the display button device.

Referring to FIG. 8a, a hard coating layer 152 may be further formed on a surface of the fourth substrate 150. The hard coating layer 152 prevents scratching of the fourth substrate 150. The hard coating layer 152 may be formed, for example, of silicone, epoxy, urethane, acryl and equivalents.

In addition, as shown in FIG. 8b, a groove 153 may be further formed on the fourth substrate 150. The groove 153 enables the fourth substrate 150 to be easily pushed backward as well as to be easily restored to the original position when the user presses a predetermined region of the fourth substrate 150 corresponding to the button 142. Of course, the groove 153 is formed in a region corresponding to a boundary between the buttons 142, thereby not interrupting images outputted from the display.

As shown in FIG. 8c, a plurality of concave and convex patterns 154 may be further formed inside the groove 153. The concave and convex patterns 154 enable the fourth substrate 150 to be more easily pushed backward as well as to be more easily restored to the original position when the user presses the fourth substrate 150 corresponding to one of the buttons 142.

FIG. 9 is a plan view illustrating the fourth substrate of the display button device.

Referring to FIG. 9, a plurality of grooves 153 may be further formed on the fourth substrate 150. For example, the grooves 153 may be formed in a configuration as shown. Here, one region 150a defined by the groove 153 may be matched to the display region by the display and the region of the button of the third substrate. When the user presses one region 150a defined by the groove 153, the fourth substrate 150 may be somewhat pushed backward by the pressing. However, when the region 150a includes the groove 153 on its perimeter, the groove 153 allows the region 150a to be easily pushed backward because the groove 153 allows for flexibility. In addition, when the user releases the region, the region 150a returns to the original position by restoring force of the groove 153.

As described above, in the display button device various types of commands can be input and various information can be output through the buttons. A shallow user interface depth and a convenient key operation is provided by changing and displaying characters, numbers, symbols, still images and moving images according to the user's choice. The user can feel a sure sense of pressing buttons and stiffness of the display is high for the button operation and external impact and the penetration of foreign materials can be efficiently prevented.

Although exemplary embodiments of the present invention have been shown and described, it would be appreciated by those skilled in the art that changes might be made in these embodiments without departing from the principles and spirit of the invention.

What is claimed is:

1. A display button device, comprising:
a display;
a first substrate located on the display, the first substrate comprising a plurality of holes;
a second substrate located on the first substrate, the second substrate comprising:
a plurality of openings formed on regions corresponding to the holes of the first substrate; and
a plurality of switches corresponding to edges of the openings;
a third substrate located on the second substrate, the third substrate having a plurality of buttons formed on regions corresponding to the openings and the switches; and
a fourth substrate located on the third substrate.

2. The display button device of claim 1, wherein the display is one selected from: a passive matrix organic light emitting display, an active matrix organic light emitting display and a liquid crystal display.

3. The display button device of claim 1, wherein the first substrate is formed from metal, ceramics or plastic.

4. The display button device of claim 1, further comprising a barrier wall formed at a region between the openings so as to separate images of the display, wherein the region corresponds to the hole of the first substrate.

5. The display button device of claim 1, wherein the switch formed on the second substrate is formed at a region corresponding to an edge of the hole formed on the first substrate.

6. The display button device of claim 1, wherein the switch formed on the second substrate is a forwardly projected dome switch.

7. The display button device of claim 1, wherein the switch formed on the second substrate is formed of a first dome switch forwardly projected and a second dome switch connected to an upper part of the first dome switch.

8. The display button device of claim 1, wherein the second substrate is a circuit board.

9. The display button device of claim 1, wherein the third substrate is made of transparent polycarbonate.

10. The display button device of claim 1, wherein the button formed on the third substrate is formed of a first region connected to the third substrate and a second region extending from the first region and separated from the third substrate by a cut.

11. The display button device of claim 10, wherein the second region of the button is configured to contact to the switch formed on the second switch.

12. The display button device of claim 1, wherein a projection is formed on the button formed on the third substrate so as to contact the switch.

13. The display button device of claim 10, wherein a projection is formed on the second region so as to be in contact with the switch.

14. The display button device of claim 12, wherein the projection is made of an elastomer.

15. The display button device of claim 1, wherein the fourth substrate is made of a transparent PET (polyethylene terephtalate) resin or a transparent silicone resin.

16. The display button device of claim 1, wherein a groove is formed at a region on a surface of the fourth substrate, and wherein the region corresponds to a boundary of the buttons formed on the third substrate.

17. The display button device of claim 16, wherein a plurality of concave and convex patterns are formed on a surface of the groove.

18. The display button device of claim 1, wherein the fourth substrate comprises a hard coating layer on its surface.

19. The display button device of claim 18, wherein the hard coating layer is formed from silicone, epoxy, urethane or acryl.

20. The display button device of claim 1, wherein the display, the first substrate, the second substrate, the third substrate, and the fourth substrate are fixed by a bezel.

21. The display button device of claim 1, wherein the display is configured to display one of a plurality of images through each of the buttons, wherein the image displayed through each of the buttons is related to the function of each of the buttons.

22. The display button device of claim 21, wherein the display is configured to change the image through each of the buttons, and to change the function of the button, wherein the new image displayed through each of the buttons is related to the new function of each of the buttons.
